(19) United States
(12) Patent Application Publication
(10) Pub. No.: US 2026/0249444 A1
(43) Pub. Date: Aug. 27, 2026

(54) System and Method for Aligning A Materials Processing Implement

(71) Applicant: Vectis Automation, LLC, Loveland, CO (US)

(72) Inventors: Andrew Akey, Windsor, CO (US); Joshua Pawley, Windsor, CO (US); Douglas Rhoda, Timnath, CO (US); Marcus Yakawich, Windsor, CO (US); Zachary Bennett, Fort Collins, CO (US); Elliot McCormick, Fort Collins, CO (US); Jacob Bell, Fort Collins, CO (US)

(73) Assignee: Vectis Automation, LLC, Loveland, CO (US)

(21) Appl. No.: 19/546,341

(22) Filed: Feb. 21, 2026

Related U.S. Application Data
(60) Provisional application No. 63/761,229, filed on Feb. 21, 2025.

(51) Int. Cl. B25J 9/00; B25J 11/00

(52) U.S. Cl. CPC B25J 9/0081; B25J 11/0055

(57) ABSTRACT

A highly mobile readily re-deployable collaborative robot fabrication system for the assembly, construction, fabrication, and/or the completion of weldments or performing cutting operations in fabrication shop or factory environments or on large structures in difficult to access or elevated locations, the fabrication system including a control system for implementing and executing a method for programming and aligning a welding or cutting implement of the readily re-deployable collaborative robot fabricating system with complex non-flat surfaces of raw work materials to produce precise structural components therewith.

### CROSS-REFERENCE TO RELATED APPLICATIONS

This application claims priority to U.S. Provisional Patent Application Serial No. 63/761,229 filed on February 21, 2025, the entire contents of which are incorporated herein by reference.

### FIELD OF THE INVENTION

The present invention relates generally to fabrication systems for use in manufacturing operations. More specifically, the present invention relates a control system and method for programming a readily re-deployable highly mobile collaborative robotic welding and/or cutting system. In particular, the present invention relates to a control system and method for programming and aligning a welding or cutting implement of a readily re-deployable collaborative robotic manufacturing system with complex non-flat surfaces of raw work materials to produce precise structural components therewith.

### BACKGROUND OF THE INVENTION

The fabrication of assemblies formed of metal structural elements and components having complex non-linear shapes, joint surfaces and edges requires the preparation and processing of the structural elements and components, for example, beveling the edges thereof, by skilled metal processing workers or by using complex, highly-automated systems designed to generate the components’ complex non-linear shapes, joint surfaces and precise edges mandated for quality joint fit up. The structural components may be manufactured using both ferrous and non-ferrous base metal alloys. The physical properties, chemical composition, sensitivity to oxidation and heat transfer characteristics of various alloys demand close attention to materials processing techniques used to fabricate a wide variety of structures and products. As noted above, joint fit up is critical to the fabrication of multicomponent products, particularly to the fabrication of multicomponent products that are adaptable to automated, high-volume production processes. Completed structures may be assembled by using mechanical fasteners, adhesives, materials joining techniques such as welding and brazing or a combination of some or all of the foregoing. Exemplary structures extend at one end of the spectrum from commonplace household appliances, furniture, exercise and lawn maintenance equipment to expensive and sophisticated space and airborne platforms, military equipment, scientific apparatus, chemical processing systems and medical devices fabricated from exotic metals. The list is endless.

A knowledgeable machinist or welder may assess the requirements of a particular job based upon prior experience and may adjust one or more machining input variables such as material and machine tool selection, cutting speed, cut sequencing and so forth. Proper weld joint preparation likewise requires detailed knowledge of materials characteristics such as thermal conductivity, cutting process selection, preheat and post heat requirements as needed to prevent cracking, and other variables. Cutting and welding implement alignment, current and voltage settings, gas flow rates and so forth are important parameters that must be implemented correctly and consistently to achieve the desired edge configuration with the precision required for proper assembly or to achieve the desired weld penetration and weld bead configuration from both a functional and an aesthetic perspective.

In the materials joining phase of the manufacturing process, optimal weld quality depends not only on proper welding parameter settings as noted above, but also on physical consistency of the path and alignment angle of the weld torch with the surfaces of raw work materials; intangibles which may be influenced by an individual welder’s skills; variable situational influences including concentration, fatigue, and health issues; and operating environment factors such as heat, humidity, lighting and ventilation. These factors are particularly influential on weld quality where the welding process is performed with a hand-held electrode or torch. The same considerations apply to cutting operations.

Automated welding and cutting systems have been developed to enhance weld joint and cut edge quality, consistency, and productivity by minimizing the adverse effects of variable welding and cutting process parameter inputs and variable or inconsistent human performance. In many cutting applications, automated systems have replaced the historical hand-held, hand-guided cutting torch. Similarly, in welding applications, the coated or “stick” electrode process has been replaced by automated continuous wire feed systems such as Gas Metal Arc Welding (GMAW), flux-cored arc welding (FCAW), gas tungsten arc welding (GTAW) or submerged arc welding (SAW) systems. The afore-mentioned automated processes may be used in connection with work-holding fixtures, weld head positioners and robot systems that can be programmed for specific welding applications. Nonetheless, if an operator enters incorrect parameter settings or fails to notice technical process irregularities during the course of fabricating a weldment, inevitably, scrap and rework will be the result. Even more serious is the possibility of catastrophic field failure of a welded structure, for example a bridge truss or an airframe, both of which may result in personal injury or loss of life.

Consequently, manufacturers are under tremendous stress to increase welding and cutting operation productivity through automation but currently have only risky and costly options to do so. Automated robot welding and cutting systems present a significant financial risk, are bulky and expensive, require a large spatial area for installation and operation, and are associated with long delivery times, significant set-up time and cost, and what operations managers view as "well, no-turning-back now" risk. While larger corporations may be able to bear the cost and risk of traditional automation, the smaller shops that make up 75% of America's 250,000+ manufacturers are prohibited by the high capital investment requirements from availing themselves of the advantages offered by either partially or fully automated systems. Moreover, the problems associated with the fabrication of large structures is exacerbated by the challenge and difficulty involved in remotely deploying collaborative robots, also known as “cobots”. Few practical means of welding on larger structures exist that do not require a large, expensive, and very precise operating and control system typically anchored to the concrete floor of a building or shop to position and operate the cobot or robot.

In response to the above needs, relatively inexpensive, mobile and versatile cobot fabrication systems have been developed which are capable of producing weldments and cut edges of the highest quality while also amenable to being programed, set up and operated by less experienced individuals in both high mix, low volume production environments and also on massive assemblies where the fabrication system may be positioned in uncomfortably elevated positions. These mobile and versatile collaborative robot fabrication systems perform welding and cutting operations that can be set up and programmed intuitively by an operator without the need for significant computer programming and coding training. They also address a need for a readily re- deployable and transportable automated fabrication system that may be installed in the field or in a manufacturing operation and moved from one worksite to another without significant labor or rigging or substantial acquisition and installation capital expenditures, dedicated floor space, or ancillary internal support and operating systems.

More advanced mobile collaborative robot systems use a traditional robot with one or more work holding positioners, interactive programming systems which permit an operator to program a desired weld or cut path and associated process parameters for a particular job on multiple fabrication system stations and move from one to the next in sequence as the operations are performed and completed. Nonetheless, while processing paths on flat work material surfaces are relatively easy to plan and to program start, end, and intermediate waypoints by jogging a machine, robot or cobot in a linear or curvilinear fashion using cartesian or polar coordinates, aligning a welding or cutting implement to work material having a non-flat surface presents unique challenges. Where the surface curvature is uniform, angle finders or angle gauges may be used to set the initial angle between the implement and the work material surface, for example executing a circumferential weld path around a cylinder or the circumference of a planar slice through a sphere. However, the alignment problem is complicated even further if the work material surface is irregular or composed of complex interconnected shapes or curved geometries where the maintenance of a constant angle between the implement and the work material surface requires complex programming and continuous instantaneous adjustment as the implement moves along the work material surface.

In view of the above, it is evident that a need exists for a mobile collaborative robot material fabrication system which allows for execution of cutting or welding operations on work materials and/or complex parts having complex interconnected surface shapes or curved geometries while maintaining a constant preselected optimum angle between the material processing implement and work material surface. The present invention addresses the aforementioned needs in the art as well as other needs, all of which will become apparent to those skilled in the art from the accompanying disclosure.

### SUMMARY OF THE INVENTION

In accordance with the embodiments of the present invention, a highly-mobile collaborative robot fabrication system is disclosed including a cobot and a programmable control system adapted to execute a preselected programed process for aligning and maintaining a material processing implement, by way of example, a welding or cutting implement, at a preselected angle between the implement and an irregular surface of work material to be processed, the irregular work material surface having complex interconnected shapes and/or curved surface geometries.

In an embodiment, a highly-mobile collaborative robot fabrication system includes a programmable control system having a memory for implementing and storing a method for aligning and maintaining a welding or cutting implement at a preselected angle between the implement and an irregular surface of work material to be processed whereby welding or cutting tasks related to weld joint preparation and the initial assembly, construction, fabrication and/or completion of prescribed weldments thereon are executed, the prescribed weldments including tack welds adapted to hold together components of the work material, performing the welding tasks associated with executing a specified weldment, and/or completing a partially finished welding project.

In another embodiment, a highly-mobile collaborative robot fabrication system includes a. control system and method for programming, aligning and maintaining a welding or cutting implement at a preselected angle between the implement and any type of regular or irregular surface of work material to be processed , the method including specific learning techniques adapted to teach the cobot to recognize any work material surface shape or feature.

In yet another embodiment, a highly-mobile collaborative robot fabrication system includes a control system having a surface feature storage memory adapted to save a taught surface shape or feature.

In still another embodiment, a highly-mobile collaborative robot fabrication system includes a control system having a memory and a shape tool which allows an operator to plot or teach a surface shape of a work material, store or save the surface shape in the control system memory, map a saved work material surface shape onto a surface of work material to be processed, and to execute a prescribed weld or cutting path on the work material.

In another embodiment, a highly-mobile collaborative robot fabrication system includes a control system which includes a free programming feature adapted to allow an operator to teach way points along a welding or cutting path on a work material surface.

In yet another embodiment, a highly-mobile collaborative robot fabrication system includes a control system which includes an alignment tool adapted to align a welding or cutting implement with a preselected work material surface feature and to execute a welding or cutting path thereon.

In still another embodiment, a highly-mobile collaborative robot fabrication system having a. control system and method for programming, aligning and maintaining a welding or cutting implement at a preselected angle between the implement and any type of regular or irregular work material surface includes a user interface or a teach pendant adapted to allow work material processing programming to be completed in an intuitive and graphical manner without requiring significant and specific education, training or computer programming and coding experience or skills.

In another embodiment, a highly-mobile collaborative robot fabrication system having a. control system and method for programming, aligning and maintaining a welding or cutting implement at a preselected angle between the implement and any type of regular or irregular surface of work material to be processed includes a mobile platform or cart adapted to move the highly-mobile collaborative robot fabricating system to the work material without requiring the use of extensive labor resources and/or rigging systems.

In yet another embodiment, a highly-mobile collaborative robot fabrication system includes a power supply, a programmable collaborative robot arm adapted to hold at least one fabricating implement, the collaborative robot arm being operatively connected to a moveable base or cart, the moveable base or cart being adapted to store fabrication system accessory equipment, a programmable control system adapted to store and execute a method for aligning and maintaining a preselected angle between the at least one fabricating implement and any type of regular or irregular surface of work material to be processed, the moveable base or cart being further adapted to stow and transport the power supply, the programmable collaborative robot arm, and the at least one fabricating implement to the work material to be processed.

In another embodiment, the movable base or cart includes a mobile platform.

In still another embodiment, a highly-mobile collaborative robot fabrication system accessory equipment includes an automatic tcp sensor, a water cooler, and a wire feeder.

These and other features, aspects and advantages of the present invention will become apparent to those skilled in the art from the following detailed description of preferred embodiments taken in connection with the accompanying drawings, which are summarized briefly below.

### BRIEF DESCRIPTION OF THE DRAWINGS

Referring now to the attached drawings which form a part of this original disclosure:

FIG. 1 is a front right top perspective view of the elements of a highly-mobile collaborative robot fabrication system having a mobile base and a control system including a shape tool, a teach pendant for implementing a method for programming, aligning and maintaining a welding or cutting implement at a preselected angle between the implement and an irregular work material surface, and a surface feature storage memory for saving a taught surface shape feature in accordance with an embodiment of the present invention;

FIG. 2 is a rear left top perspective view of the collaborative robot fabrication system of FIG. 1 in accordance with an embodiment of the present invention;

FIG. 3 is a front left top perspective view of the collaborative robot fabrication system configured for performing welding operations in accordance with an embodiment of the present invention;

FIG. 4 is a front view of the collaborative robot fabrication system of FIG. 3 in accordance with an embodiment of the present invention;

FIG. 5A is a flow diagram illustrating the steps of a method for programming, aligning and maintaining a welding or cutting implement at a preselected angle between the implement and any type of regular or irregular surface of work material to be processed in accordance with an embodiment of the present invention;

FIG. 5B is a continuation of the steps of the method depicted in FIG. 5A;

FIG. 6 is an image of a control panel or teach pendant screen illustrating the steps of teaching points defining the axis of a cylinder in accordance with an embodiment of the present invention;

FIG. 7 is an image of a control panel or teach pendant screen illustrating the steps of teaching points defining the circumference of a cylinder in accordance with an embodiment of the present invention;

FIG. 8 is an image of the teaching points defining the surface of a semi-spherical or dome shaped surface of work material to be processed in accordance with an embodiment of the present invention;

FIG. 9 is an image of the teaching points defining the surface of a truncated cone shaped surface of work material to be processed in accordance with an embodiment of the present invention;

FIG. 10A illustrates the unadjusted taught programming point of a welding implement approaching a cylindrically shaped work piece from the top left thereof in accordance with an embodiment of the present invention;

FIG. 10B illustrates the welding implement depicted in FIG. 10A following perpendicular alignment thereof to the surface of the cylindrically shaped work piece in accordance with an embodiment of the present invention;

FIG. 10C illustrates a representative approach point for initiating a searching procedure for a start point in accordance with an embodiment of the present invention; and

FIG. 10D illustrates executing a tactile searching feature using a spot sensor, for example, a laser, a camera, or a light projector to perform the searching function in accordance with an embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claim and its equivalents.

### Overview of System Operation

A highly-mobile collaborative robot fabrication system configured as a welding or a cutting system in accordance with an embodiment of the present invention addresses the afore-mentioned needs of the industry by providing a welding or cutting system that may be taken to the work material, set up, and placed in production in less than a few hours. The highly-mobile collaborative robot fabrication system includes a movable base, platform or cart including a cart adapted to store fabrication system accessory equipment, the movable base, platform or cart further being adapted to support a collaborative robot, also referred to herein as a cobot, the cobot having a robot arm adapted to hold and guide a material processing implement such as a welding or cutting implement in response to a control system material processing program, programming and control systems’ instructions and select ancillary equipment such as by way of example and not of limitation, a wire feed system, an automatic tcp (tool center point) system, and a water cooler, all of which are positioned on the cart. Cobots are lightweight in comparison to traditional robots. Accordingly, the mobile platform or cart and the fabricating equipment positioned thereon may be moved into position adjacent a large assembly or selectively and securely placed in position directly on the assembly for performing welding or cutting operations. Contrasted with the weight of much larger robotic systems, the lighter weight of the collaborative robot welding or cutting system of the instant invention makes this deployment method feasible and readily amenable to implementation in diverse fabrication scenarios.

The highly-mobile collaborative robot fabrication system further includes a user interface or a teach pendant adapted to allow control system programming to be completed for any given job in an intuitive and graphical manner without requiring significant and specific education, training or computer programming/coding experience or skills. Accordingly, in a scarce labor market, where an extreme shortage of skilled welders exists, the collaborative robot fabrication system of the present invention permits manufacturers of welded products to meet the high demand for those products economically.

In operation, the operator/programmer either brings the work materials to be cut or welded to the collaborative robot, for example in fabrication shop or factory environments, or, alternatively, brings the robot to the work material to be processed. If the collaborative robot is taken to the work material, the welder or plasma cutting power supply is plugged into available single phase or three phase wall power and the collaborative robot is plugged into an available 120V outlet. Once both devices are powered on, the operator/programmer starts positioning the collaborative robot for the work material which may be held in a non-collaborative positioner operatively connected to the cart or located adjacent thereto. The first positions that the operator/programmer will teach are clearance moves of the robot arm, designated as “AirMove’s” to position the robot in preparation for the cutting or welding task at hand. The primary means of moving the collaborative robot and the welding gun to the work material is via a programming button that releases the robot into a hand-guided jogging mode where the operator/programmer can push/pull the robot into an appropriate position. When the operator/programmer starts positioning the collaborative robot, he/she ensures that they have a blueprint or a material processing procedure document that will be used to identify the start point and the size and type of welding or the shape and location of the cutting to be performed on the work material. If the work material to be processed varies in positional location or in the situation where the collaborative robot is moved to the work material, tactile searching/sensing is needed to ensure that the trajectory of the robot is properly placed in the joint or at the cut in light of the positional location variation. If one of these conditions exists, the operator/programmer plans out the searching scheme and weld or cut path offsets if needed.

As noted above, laying out a weld or cut path on and aligning a welding or cutting implement to flat surfaces are relatively straightforward, since an operator can normally jog a machine, robot or cobot in a linear fashion in an x, y, or z direction to plan processing path waypoints and to create a processing program. However, aligning an implement to a non-flat surface is typically difficult, and the required process programming is generally performed offline with a computer analyzing CAD geometry input data to allow the computer to compute correct alignment of the programming points and implement orientation relative to the surface. This solution requires both computer and cobot expertise, a combination of specialties not normally found in a welding or cutting system operator’s skillset.

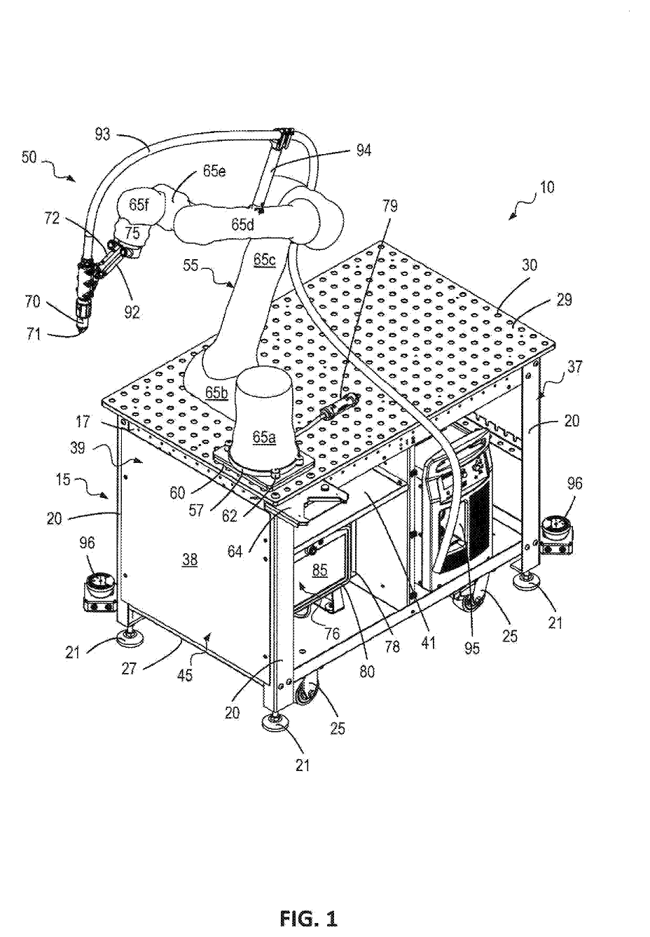

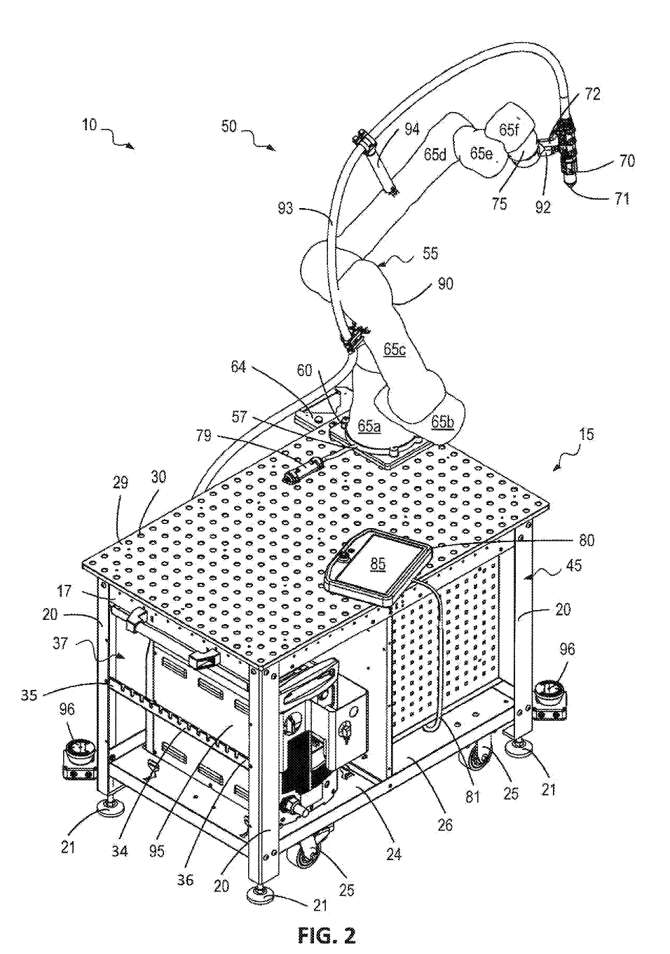

Referring initially to FIGS. 1 and 2, an exemplary collaborative robot fabrication system is shown generally at the numeral 10. In the embodiment of FIG. 1, the fabrication system is in the form of a cutting system; however, it is to be understood that other material processing systems, such as a welding system, incorporating the novel features of the present invention may be included without departing from the scope of the present invention. The cutting system includes a mobile base or cart 15, as the terms may be used interchangeably herein, having a frame 17, a plurality of supporting legs 20, each including a levelling device or foot 21 attached thereto, a storage area or platform 24 having an upper surface 26, a bottom surface 27 having a plurality of wheels or casters 25 mounted thereto, and a gridded upper work surface or table 29. The upper work surface includes a plurality of apertures 30 formed therein, each of the apertures being adapted to releasably receive a clamp or other securement device for holding a workpiece, fixture or assembly in a fixed position during the performance of a cutting sequence using the cutting system. The mobile worktable, base or cart further include a cross member or spacer 34 extending laterally across a rear end portion 37 of the mobile worktable and operatively connected at each of opposite ends 35 and 36 thereof to one of the plurality of supporting legs 20 and a plate or panel 38 covering a front end portion 39 of the mobile worktable and a storage shelf 41; the frame, the plurality of supporting legs, the upper surface 26 of the platform 24, the table 29, and the plurality of casters 25 cooperating to form the moveable base or cart 45 adapted to store fabrication system accessory equipment.

The cutting system 10 further includes a collaborative robot system 50 (known in the art as a cobot), such as a Universal Robots^{™} UR10e collaborative industrial robot. However, it is to be understood that collaborative robot systems either specifically designed and built for individual applications or other generally commercially available collaborative robot systems may also be used without departing from the scope of the present invention. The collaborative robot system comprises a robot arm 55 operatively connected to a base 57, which, in turn, is mounted on an electrically isolating pad 60 secured by suitable fasteners 62 to the upper work surface 29. A tool center point (“tcp”) sensor 64 is conveniently secured to the upper work surface or table 29 and is adapted to permit an operator to determine the exact point where a cutting or welding implement interacts with the work material being processed. The interaction point is important to maintain proper positioning and orientation of a cutting or welding implement upon the initiation and throughout the performance of a processing procedure to ensure precise, consistent high quality product output.

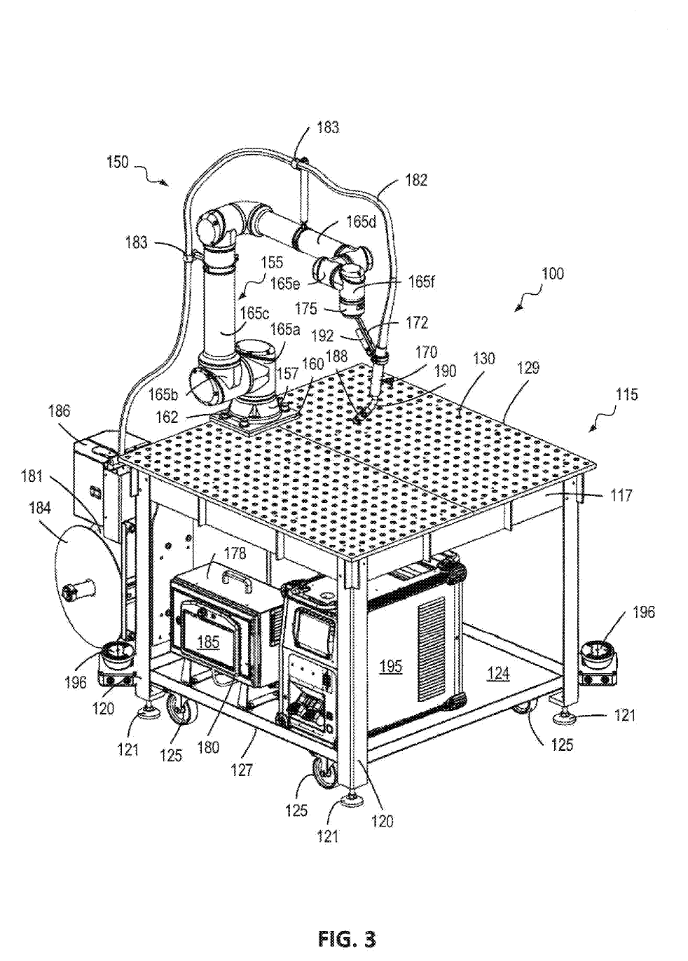

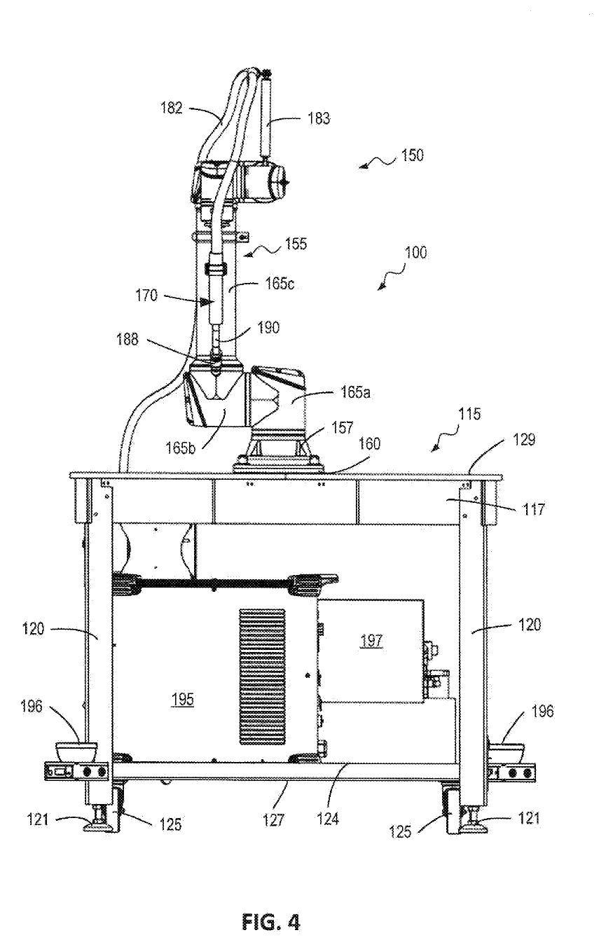

As best seen in FIG. 2, the robot arm includes a plurality of arm segments 65a-65f sequentially pivotally and/or rotatably interconnected to one another and structured and arranged to have a reach length or distance which depends upon the size of the robot arm selected for use in the system 50 and the lengths of its individual segments. A work material processing implement 70 is secured via an attachment 72 to a distal end 75 of the robot arm, the implement being universally positionable and translatable along a preselected path in response to instructions from a control system 76which includes robot controller 78 (Fig, 1) operatively connected to the cobot via robot control connector 79, teach pendant 80 operatively connected to the robot controller via cable 81 (FIG. 2), and application programming interface (API) display 85. The teach pendant 80 and cable 81 are configured to permit an operator to hang the teach pendant on the robot controller 78 or to conveniently hand-carry the teach pendant to any point around the work table and/or position it thereon as shown in FIG. 2 while performing setup or measuring operations. In the embodiment of FIG. 1, by way of example and not of limitation, the implement 70 is depicted in the form of a cutting torch and cutting nozzle 71 representative of the type used in plasma cutting processes; however, it is to be understood that the system of the present invention may be used with any cutting or welding process and implement without departing from the scope of the present invention. Moreover, in the embodiment of FIG. 1, the members of the collaborative robot system 50 are shown as being optionally covered by a protective material or shield wrap 90 to protect the elements thereof from spatter generated by cutting operations. The welding system described in FIGS. 3 and 4 below does not include this optional protective material or shield wrap.

The control system includes a point by point programming feature or capability which allows an operator to teach way points along a welding or cutting path on any type of regular or irregular work material surface and to align and maintain a welding or cutting implement at a preselected angle between the implement and a regular or irregular work material surface. The control system further includes a shape tool feature which allows an operator to teach a work material surface shape, save the taught shape in a surface feature storage memory, and to map a saved material surface shape onto a work material surface to execute a welding or cutting path. A programming or hand-guided jog button 92 is secured to the attachment 72 and is operatively connected to the robot controller 78 and teach pendant 80 and, as will be described in greater detail below, is adapted to allow an operator to set up and program the system in an intuitive and graphical manner. Compressed air and cutting consumables such as cutting gas are delivered from a central gas supply system or from individual gas cylinders along with electrical power cables via a torch bundle 93 supported by support arm or bracket 94 secured to the robot arm and to the cutting nozzle 71, as is known in the art. Power is provided to the implement via power supply 95, and the power supply, robot controller, teach pendant, and any ancillary power tools an operator may need all may be operatively connected to single phase power, for example, 120V power for the collaborative robot system and 240V power for the power supply. Optionally, the power supply may be connected to 208V, 480V or 575V three phase power.

The system further includes an optional corner-mounted operator protection safety system 96 as illustrated in FIGS. 1 and 2 which detects the presence of an operator, other personnel or a vehicle such as a forklift in preselected safety zones or non-visible safety barriers generated by the corner-mounted operator protection safety system and surrounding the collaborative robot fabrication system. When an object is detected in one of the zones, the operating speed of the robot system is reduced for safety purposes or the robot system is stopped if used with the motorized rotation system. Coupled with a built-in safety system of the robot arm, which stops its movement when the arm contacts an object, the system possesses dual chain safety feature redundancy. This feature also enhances production rates, inasmuch as the system may be operated confidently at higher speeds under normal conditions knowing that if an unsafe condition is detected, the system will respond proactively to protect the operator and other personnel in the area.

Referring now to FIGS. 3 and 4, a collaborative robot welding system 100 having an extended worktable or mobile cart 115 is illustrated in accordance with an embodiment. Similar in construction and operation to the embodiment of FIGS. 1 and 2, welding system 100 includes an XL worktable or mobile cart 115 having a full system footprint of approximately four (4) feet wide and six (6) feet deep. The extended worktable or mobile cart includes a frame 117, a plurality of supporting legs 120, each including a levelling device or foot 121 attached thereto, a storage area or platform 124 having wheels or casters 125 mounted to a bottom surface 127 thereof, and a gridded upper work surface or table 129. The upper work surface includes a plurality of apertures 130 formed therein, each of the apertures being adapted to releasably receive a clamp or other securement device for holding a workpiece, fixture or weld assembly in a fixed position during the performance of a welding sequence using the welding system. Upon a specific customer’s request, the system may include an optional corner-mounted operator protection safety system 196. As described above, the operator protection safety system detects the presence of an operator, other personnel or a vehicle such as a forklift in preselected safety zones or non-visible safety barriers generated by the corner-mounted operator protection safety system and surrounding the collaborative robot welding system 100.

The collaborative robot welding system 100 further includes a collaborative robot system or cobot 150 as shown and described in detail above with respect to the embodiment of FIGS. 1 and 2. For purposes of clarity and simplicity, the analogous robot system component numeric identifiers that are shown in FIGS. 1 and 2 are increased by 100 are also used in the embodiment of FIGS. 3 and 4. Collaborative robot systems either specifically designed and built for individual applications or other generally commercially available collaborative robot systems may also be used in the embodiment of FIGS. 3 and 4 without departing from the scope of the present invention.

Welding consumables such as protective shielding gas, granular flux material and welding wire 181 are delivered to the welding implement via conduit or welding torch bundle 182 secured to the robot arm segments 165c and 165d by conduit or bundle management brackets 183. The wire is stored in a suitable wire storage apparatus such as a drum or, by way of example and not of limitation, on a wire spool 184 and fed by a wire feed mechanism 186 from the spool through the conduit or bundle and to a weld joint assembly via a weld nozzle 188 operatively connected to a distal end 190 of the torch. A programming or hand-guided jog button 192 is secured to the attachment 172 and is operatively connected to the robot controller 178 and teach pendant 180 and is adapted to allow an operator to set up and program the welding system in an intuitive and graphical manner. Shielding gas is delivered from a central gas supply system or from individual gas cylinders via the torch bundle to the weld nozzle, as is known in the art. As applicable to all of the embodiments of the collaborative welding system herein described, power is provided to the welding implement via welding power supply 195, and the welding power supply, robot controller, teach pendant, wire feed mechanism, water cooler 197, and any ancillary power tools an operator may need all may be operatively connected to single phase power, for example, 120V power for the collaborative robot system and 240V power for the welding power supply. Optionally, the welding power supply may be connected to 208V, 480V or 575V three phase power.

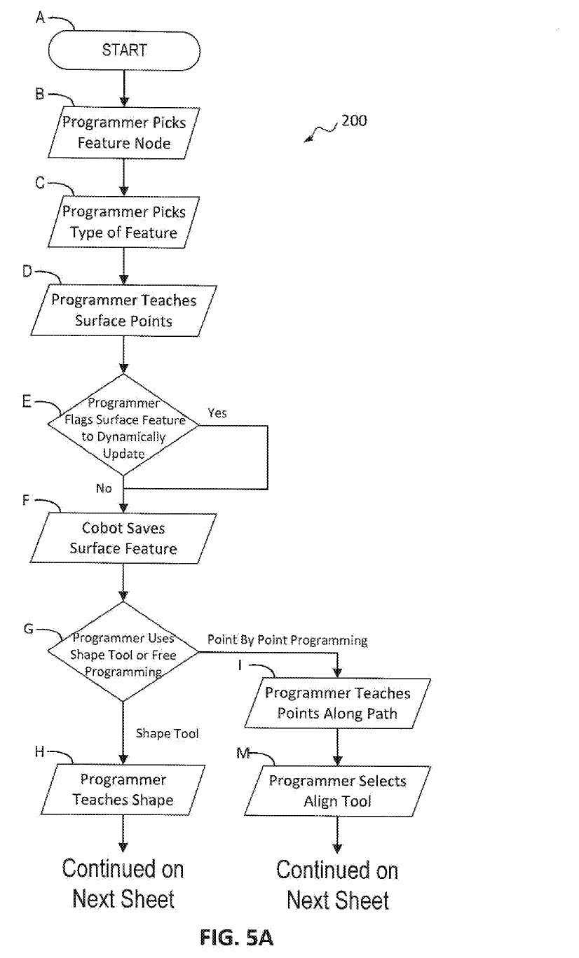

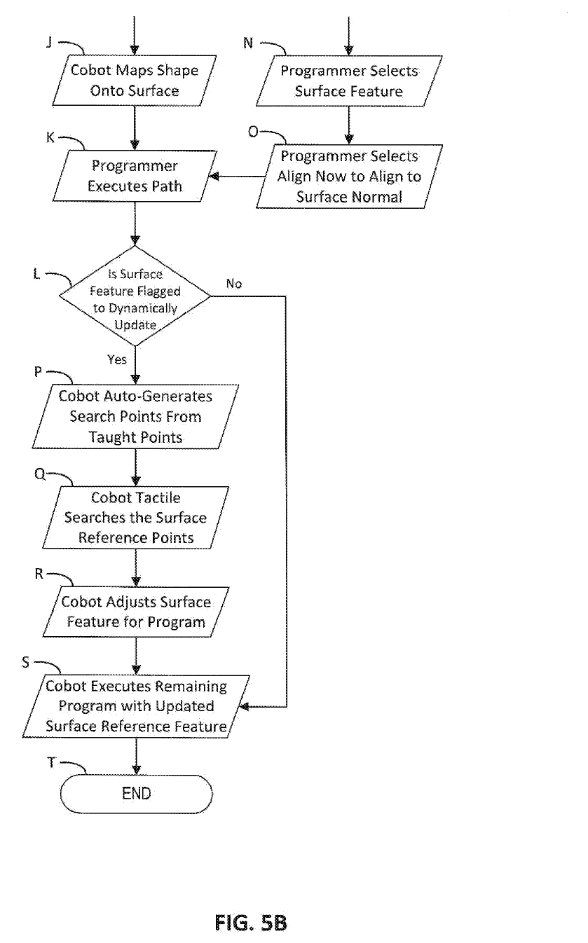

Referring now to FIGS. 5A and 5B, a flow diagram illustrates the workflow and operational sequences of the method 200 of the present invention which addresses the aforesaid problems by merging the implement alignment and operator safety features onto the cobot, thereby making it more powerful. The method uses the measurement system of the cobot in conjunction with geometrical mathematics in the programming software to allow the cobot to recognize a normal vector to the work material surface at any location thereon. The advantages of the system and method of the present invention include allowing the cobot to be aware of any type of work material surface that might need to be taught and stored in the system memory or database by creating a method of identifying and learning any given surface shape with specific teaching techniques. This feature also enables the employment of operators having a broader range of experience to perform fabrication operations with a collaborative robot fabrication system by making the programming and implement alignment tools capable of being hand-held and easier to use.

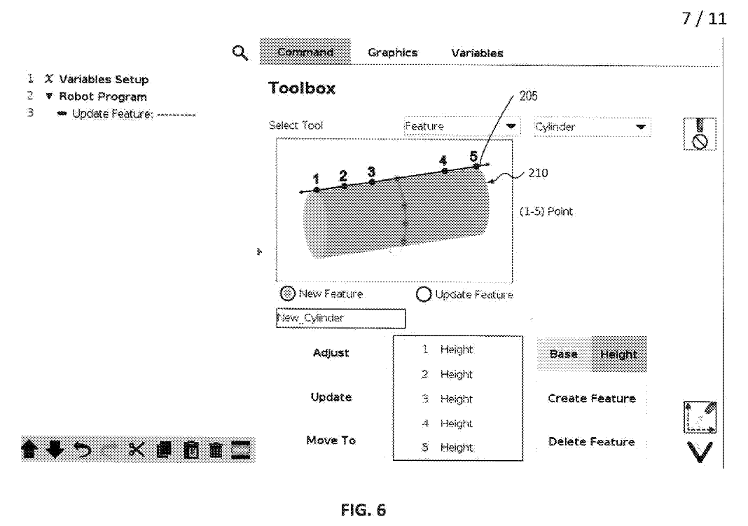

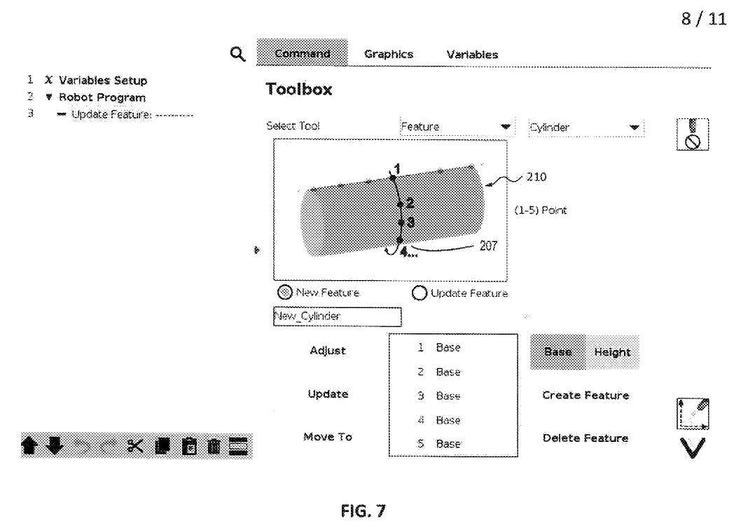

The process is initiated by an operator or programmer either bringing the work material, structure, or assembly to be processed to the collaborative robot, for example in fabrication shop or factory environments, or, alternatively, brings the robot to the work material, structure, or assembly to be processed. At a Start Point indicated at step A in FIG. 5A. At step B, the operator selects “feature node” from a library of saved nodes and then at step C, selects the type of feature to be taught. By way of example, FIGS. 6 and 7 illustrate screenshot images of a control panel or teach pendant screen illustrating the steps of teaching points defining the axis 205 of a cylinder 210 (teaching points 1, 2, 3, 4, and 5 in FIG. 6) and the steps of teaching points defining the circumference 207 of a cylinder (teaching points 1, 2, 3, and 4 in FIG. 7) which are performed at step D. At step E, the operator choses whether or not to flag the surface feature to be dynamically updated upon execution of the program. The cobot is programmed to save surface features generated by this procedure, and the operator saves each at step F of the process sequence to the control system, thus allowing the cobot to know the actual location of the cylinder exterior surface and not just a plane that is tangential to the surface.

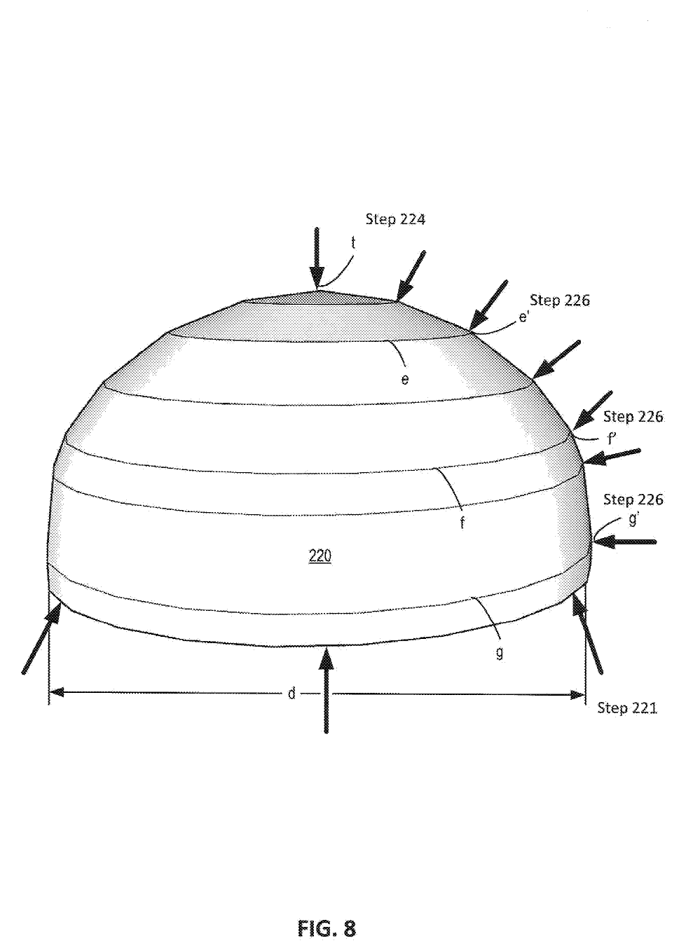

FIG. 8 illustrates the exemplary steps of the method of the present invention in teaching the surface of a dome 220. The sequence of the steps begins at the step of teaching the overall diameter d of the bottom side of the dome when it meets up to a cylinder, step 221, and then teaching the top dead center point, t, step 224. After determining the diameter d and the top dead center point t, the cobot would be taught several rings, for example rings e, f, and g by teaching the respective locations on the dome surface of these rings e’, f’ and g’, step 226. These points can be taught either with a freedrive feature or with the use of the above-referenced jogging mode selected with the teach pendant. Once this type of surface, i.e., a domed surface, is saved to a surface feature, the programmer can then use this feature to align a welding or cutting implement to the surface or to teach a shape that is mapped onto the surface, thus making programming easier and faster.

Referring again to FIG. 5A, at step G, the operator elects to use either a shape tool feature of the program to teach the shape of the work material surface at step H or, alternatively to use a point by point programming technique wherein the operator teaches points along a weld or cut path, step I. Following the shape tool processing path, after the operator teaches the shape at step H, the cobot maps the shape onto the work material surface, step J. The programmer then executes the path, step K.

Using the point by point programming technique, after executing step I, teaching points along the desired path, the operator selects an align tool at step M and a surface feature at step N (FIG. 5B). Continuing in FIG. 5B, at step O, the operator executes an “align now” step in which the system aligns the implement in an orientation normal to the work material surface and executes the processing path at step K.

Upon execution, if the surface feature is flagged to dynamically update at step L, the cobot will auto-generate search points from the taught feature points step P. The cobot will then tactile search these points either with force-based touch sensing, a laser spot sensor, or a camera step Q. Once these points are searched, the cobot adjusts the surface feature at step R for the program to be executed. The cobot executes the remaining program sequence at step S with the updated surface feature and ends the process at step T. If the surface feature is not flagged to dynamically update, the cobot will move from step L directly to step S executing the remaining program and ends the process at step T.

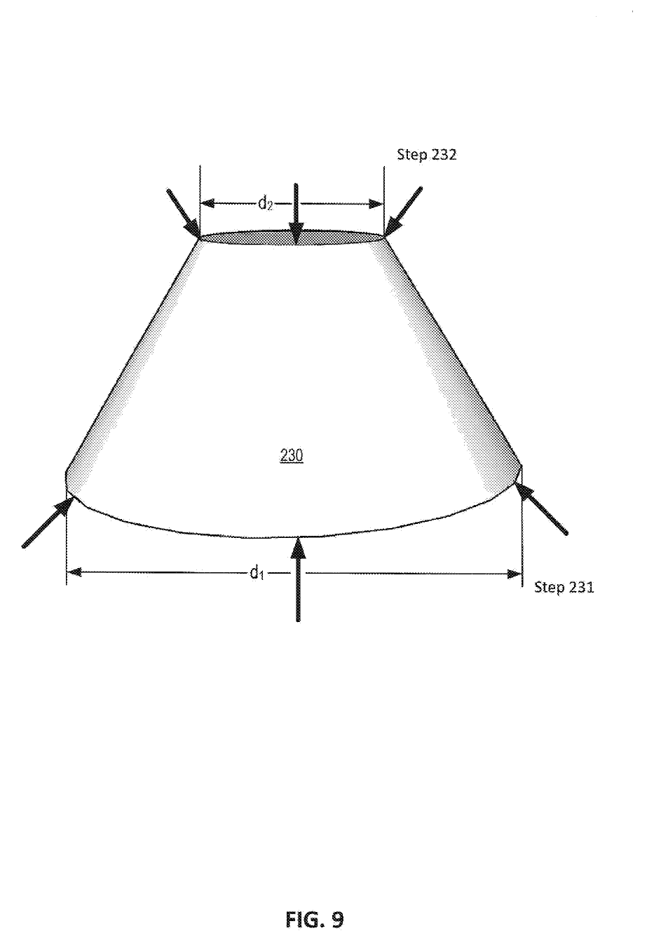

FIG. 9 illustrates the exemplary steps of the method of the present invention in teaching the surface of a truncated cone 230. The sequence of the steps begins at the step of teaching the overall diameter d₁ of the bottom side of the truncated cone, step 231, and then teaching the top diameter of the truncated cone, d₂, step 232. These points can be taught either with a freedrive feature or with the use of the above-referenced jogging mode selected with the teach pendant. Once this type of surface, i.e., a truncated cone surface, is saved to a surface feature, the programmer can then use this feature to align a welding or cutting implement to the surface or to teach a shape that is mapped onto the surface, thus making programming easier and faster.

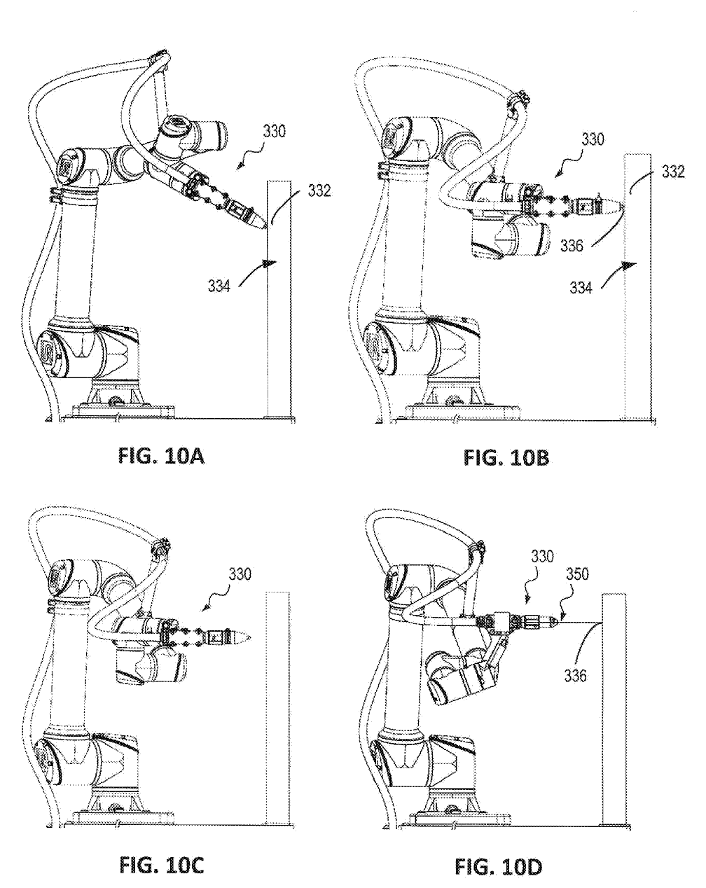

FIG. 10A depicts an exemplary approach of a cutting implement 330 to a cylindrical work surface 332 of a cylindrical structure 334 prior to initiation of the alignment steps of the method of the current invention.

FIG. 10B illustrates the alignment of the implement 330 shown in FIG. 10A in a direction normal to the cylindrical work surface 332 of the cylindrical workpiece 334 following execution of the alignment step and establishing an initial contact point 336, whereupon the processing of the cylindrical structure 334 is initiated.

FIG. 10C illustrates a representative approach point of a processing implement 330 for a surface feature when used to dynamically update the surface feature with tactile searching with a contact point 336 as shown in FIG. 10B.

FIG. 10D illustrates positioning a processing implement 330 using the above-referenced tactile searching feature using a spot sensor 350, for example, a laser, a camera, a light projector and the like to establish a contact point 336.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A highly-mobile collaborative robot fabrication system adapted to perform processing operations on raw work material, structures, and assemblies having irregular surfaces, the irregular surfaces of the raw work material, structures and assemblies having complex interconnected shapes and/or curved surface geometries, the highly-mobile collaborative robot fabrication system comprising:
a mobile base or cart adapted to store fabrication system accessory equipment therein;
a gridded upper work surface or table operatively connected to the mobile base or cart;
a collaborative robot system including a collaborative robot or cobot, the cobot having a robot arm operatively connected to a base secured to the gridded upper work surface or table, the robot arm including a plurality of arm segments sequentially pivotally and/or rotatably interconnected to one another and structured and arranged to have a reach length or distance;
a control system;
a robot controller;
a teach pendant operatively connected to and adapted to communicate with the control system and robot controller, the teach pendant further including an application programming interface (API) display;
a work material processing implement secured to a distal end of the robot arm, the implement being universally positionable and translatable along a preselected path in response to instructions from the control system, the robot controller, the teach pendant, and the application programming interface (API) display;
wherein the control system includes an operator controlled point by point programming feature whereby an operator selects and teaches way points along a processing path on any type of regular or irregular raw work material, structure or assembly surface to align and maintain the work material processing implement at a preselected angle between the implement and a regular or irregular work material surface.

2. The highly-mobile collaborative robot fabrication system of claim 1 further including tool center point (“tcp”) sensor operatively connected to the gridded upper work surface or table and adapted to permit an operator to determine the exact point where a work material processing implement interacts with the work material being processed.

3. The highly-mobile collaborative robot fabrication system of claim 2 further including an operator controlled shape tool program whereby an operator generates or teaches a work material surface shape, saves the generated taught shape in a surface feature storage memory of the control system, and selectively maps a saved work material surface shape onto a selected work material surface to execute a processing path.

4. The highly mobile collaborative robot fabrication system of claim 3 further including a programming or hand-guided jog button operatively connected to the robot controller and teach pendant, the programming or hand-guided jog button being adapted to allow an operator to set up and program the highly-mobile collaborative robot fabrication system in an intuitive and graphical manner.

5. The highly mobile collaborative robot fabrication system of claim 4 further including a corner-mounted operator protection safety system adapted to detect the presence of an operator, other personnel or a vehicle in preselected safety zones or non-visible safety barriers generated by the corner-mounted operator protection safety system and surrounding the collaborative robot fabrication system.

6. The highly mobile collaborative robot fabrication system of claim 1 further including a corner-mounted operator protection safety system adapted to detect the presence of an operator, other personnel or a vehicle in preselected safety zones or non-visible safety barriers generated by the corner-mounted operator protection safety system and surrounding the collaborative robot fabrication system.

7. The highly mobile collaborative robot fabrication system of claim 5 wherein the work material processing implement is a welding implement.

8. The highly mobile collaborative robot fabrication system of claim 6 wherein the work material processing implement is a welding implement.

9. The highly mobile collaborative robot fabrication system of claim 5 wherein the work material processing implement is a cutting implement.

10. The highly mobile collaborative robot fabrication system of claim 6 wherein the work material processing implement is a cutting implement.

11. A method for aligning and maintaining a material processing implement of a highly-mobile collaborative robot fabrication system at a preselected angle between the implement and an irregular surface of raw work material, a structure, or an assembly to be processed, the irregular raw work material, structure, or assembly surface having complex interconnected shapes and/or curved surface geometries, the highly-mobile collaborative robot fabrication system including a collaborative robot or cobot having a robot arm, a control system, a robot controller, a teach pendant operatively connected to and adapted to communicate with the control system and robot controller, the teach pendant further including an application programming interface (API) display, and a work material processing implement secured to a distal end of the robot arm, the implement being universally positionable and translatable along a preselected path in response to instructions from the control system, the robot controller, the teach pendant, and the application programming interface (API) display, the method comprising the steps of:
11A. either bringing the work material, structure, or assembly to be processed to the collaborative robot, or, alternatively, bringing the robot to the work material, structure, or assembly to be processed;
11B. selecting the feature node library from a library of saved nodes;
11C. selecting the type of feature to be taught from the selected feature node library;
11D. generating one or more teaching points defining the surface features of the work material, structure, or assembly to be taught;
11E. optionally flagging the surface features to be dynamically updated upon execution of the program;
11F. saving each of the one or more generated teaching points or surface features in the control system;
11G. selecting to use either a shape tool feature of the control system to teach the shape of the work material, structure, or assembly surface or, alternatively, to use a point by point programming technique wherein an operator teaches points along a processing path;
11J. mapping the shape using the cobot onto the work material, structure, or assembly surface;
11K. executing the path
11L. optionally flagging the surface features to be dynamically updated upon execution of the program;
11P. if the surface feature is flagged to dynamically update at step L, at step P, the cobot will auto-generate search points from the taught feature points;
11Q. tactile searching the auto-generated points either with force-based touch sensing, a laser spot sensor, or a camera;
11R. after the auto-generated points are searched, adjusting the surface feature for the program to be executed;
11S. executing the remaining program sequence, and
11T. ending the programmed process.

12. The method of claim 11 wherein at step G, if the operator elects to use a point by point programming feature wherein the operator teaches points along a processing path, the method further including the steps of:
12I. teaching points along the desired processing path;
12M. selecting an align tool;
12N. selecting a surface feature;
12O. executing an “align now” step whereby the system aligns the processing implement in an orientation normal to the work material, structure, or assembly surface; and
12K. transitioning to and executing steps K through T.
